(19) United States
(12) Patent Application Publication
(10) Pub. No.: US 2025/0310306 A1
(43) Pub. Date: Oct. 2, 2025

(54) SYSTEM AND METHOD FOR ENCODING AND DECODING IN COMMUNICATION PROTOCOL

(71) Applicant: Microchip Technology Incorporated, Chandler, AZ (US)

(72) Inventors: Stein Julusmoen, Trondheim (NO); Amund Aune, Heimdal (NO); Ivar Holand, Klaebu (NO); Lloyd Clark, Trondheim (NO)

(73) Assignee: Microchip Technology Incorporated, Chandler, AZ (US)

(21) Appl. No.: 19/093,416

(22) Filed: Mar. 28, 2025

Related U.S. Application Data
(60) Provisional application No. 63/570,900, filed on Mar. 28, 2024.

(51) Int. Cl. H04L 9/40

(52) U.S. Cl. CPC H04L 63/0428

(57) ABSTRACT

A system for encoding and decoding in a communication protocol is provided, and may include a transmitter having a transmit data buffer to store a data, an encoding circuitry operatively coupled to the transmit data buffer to receive the data from the transmit data buffer and encode the data based on a selected encoding method, and a transmit shift register operatively coupled to the encoding circuitry to receive the encoded data and transmit the encoded data in the bitwise manner. The system may include a receiver having a receive shift register to receive the encoded data, a decoding circuitry operatively coupled to the receive shift register to receive the encoded data from the receive shift register in a parallel manner, and decode the encoded data based on a selected decoding method, and a receive data buffer operatively coupled to the decoding circuitry to receive the decoded data.

### CROSS-REFERENCE TO RELATED APPLICATION

The present application claims priority from U.S. Provisional Patent Application No. 63/570,900, which was filed on Mar. 28, 2024, and is incorporated by reference in its entirety.

### TECHNICAL FIELD

The present disclosure relates generally to data communication, and more specifically to a system and method for encoding and decoding data in a communication protocol.

### BACKGROUND

Communication with security integrated circuits can be through proprietary interfaces, or may rely on an inter-integrated circuit (I2C) bus. Some 1-wire solutions protocols are based on communication protocols such as serial peripheral interface (SPI) or universal asynchronous receiver-transmitter (UART)/universal synchronous receiver-transmitter (USRT) that use one frame for each bit. For example, interfacing addressable LEDs may be based on SPI, where the amount of time the signal is high or low defines whether the frame is a 0 or 1. These communication protocols cause increased software overhead while encoding and decoding individual data bits due to significant computational demands on the software. Moreover, these communication protocols have limited data transfer efficiency, and restrict overall communication speed while transferring data one bit at a time. The proprietary solutions often limit compatibility to specific ICs, hindering broader applicability. Therefore, there is a need for an improved system and method for encoding and decoding data in a communication protocol.

### SUMMARY

According to an aspect of one or more examples, there is provided a system to encode and decode data in a communication protocol. The system may include a transmitter and a receiver. The transmitter may include a transmit data buffer to store data, an encoding circuitry operatively coupled to the transmit data buffer and a transmit shift register operatively coupled to the encoding circuitry. The encoding circuitry may receive the data from the transmit data buffer in a bitwise manner, select an encoding method based on a first control signal received from a first control register and encode the data based on the selected encoding method and a first plurality of reference data values. The transmit shift register may receive the encoded data and transmit the encoded data in the bitwise manner. The receiver may include a receive shift register to receive the encoded data in a bitwise manner, a decoding circuitry operatively coupled to the receive shift register and a receive data buffer operatively coupled to the decoding circuitry. The decoding circuitry may receive the encoded data from the receive shift register, which shifts the bitwise data into a full byte, before transferring the byte to the decoding circuitry in a parallel manner. The decoding circuitry may select a decoding method based on a second control signal received from a second control register and decode the encoded data based on the selected decoding method and a second plurality of reference data values. The receive data buffer may receive the decoded data.

The first plurality of reference data values for encoding may include a first encoding data value stored in a first reference register of the encoding circuitry and a second encoding data value stored in a second reference register of the encoding circuitry. The second plurality of reference data values for decoding may include a first decoding data value stored in a first reference register of the decoding circuitry, a second decoding data value stored in a second reference register of the decoding circuitry and a third decoding data value stored in a third reference register of the decoding circuitry. The system may include a baud rate generator to generate a baud rate for the system.

According to an aspect of one or more examples, there is provided a method to encode and decode in a communication protocol. The method may include receiving data in a bitwise manner from a transmit data buffer of a transmitter, selecting an encoding method based on a first control signal received from a first control register of an encoding circuitry of the transmitter, encoding the data based on the selected encoding method and a first plurality of reference data values, receiving the encoded data in a parallel manner from a receive shift register of a receiver, selecting a decoding method based on a second control signal received from a second control register of a decoding circuitry of the receiver and decoding the encoded data based on the selected decoding method and a plurality of reference data value.

The first plurality of reference data values for encoding may include a first encoding data value stored in a first reference register of the encoding circuitry and a second encoding data value stored in a second reference register of the encoding circuitry. The second plurality of reference data values for decoding may include a first decoding data value stored in a first reference register of the decoding circuitry, a second decoding data value stored in a second reference register of the decoding circuitry and a third decoding data value stored in a third reference register of the decoding circuitry. The method may include generating a baud rate.

### BRIEF DESCRIPTION OF DRAWINGS

FIG. 1 shows a block diagram illustrating a system for encoding and decoding data in a communication protocol according to one or more examples.

FIG. 2 shows a block diagram illustrating a transmitter of a system encoding in a communication protocol according to one or more examples.

FIG. 3 shows a block diagram illustrating a receiver of a system decoding in a communication protocol according to one or more examples.

FIG. 4 shows a flowchart illustrating a method for encoding and decoding in a communication protocol according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

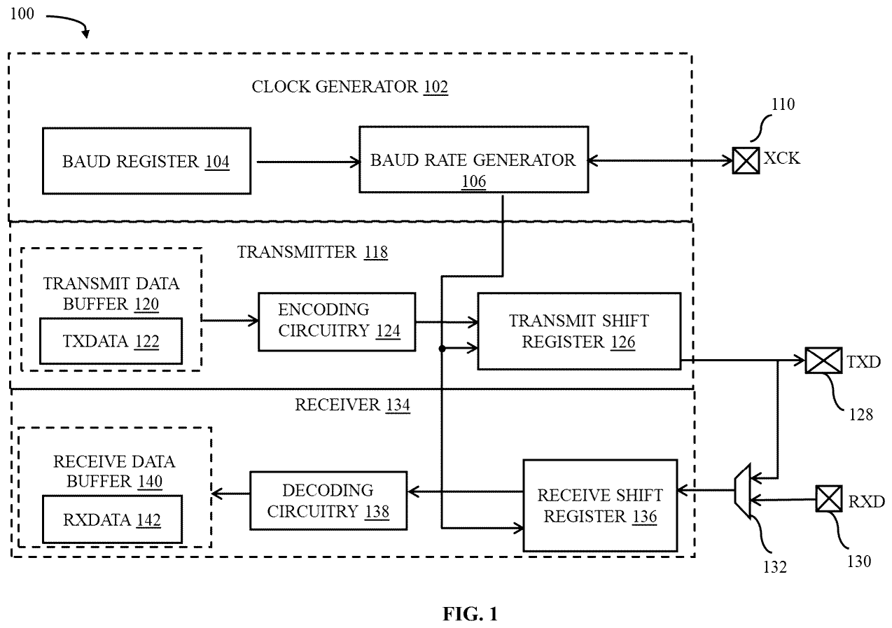

FIG. 1 shows a block diagram illustrating a system 100 for encoding and decoding in a communication protocol according to various examples. The system 100 may leverage a combination of hardware components and control logic within the communication protocol, such as a serial communication protocol, without limitation, to achieve encoding and decoding of a data transmitted in a bitwise manner. According to various examples, encoding and decoding may be built into a UART/USRT or SPI so that CPU overhead may be reduced. For example, instead of the CPU wiring a byte for every bit transmitted, one byte may be written for 8 bits. According to various examples, when a byte is written the system may encode each bit in the byte and may transmit each bit according to a selected encoding method. According to various examples, software overhead may be reduced by a factor of 8, so that one or more 1-wire protocols may be treated like SPI or UART/USRT.

Referring to FIG. 1, the system 100 may configure a plurality of settings of the serial communication protocol on a serial communication interface of the system 100. The configuration of the plurality of settings may include setting a baud value, setting a number of communication pins, setting to bi-directional (full duplex) or single directional (half-duplex) communication, designating transmit or receive buffers, or selecting a synchronous or asynchronous mode of communication.

The system 100 may include three functional blocks: a clock generator 102, a transmitter 118, and a receiver 134. The transmitter 118 and the receiver 134 may be arranged to handle serial transmission of the data sent from, and reception of the data sent to, the system 100, respectively. The clock generator 102 may produce a regular stream of electrical pulses at a specific frequency to manage timing of data transmission and reception. The clock generator 102 may include a baud register 104 and a baud rate generator 106.

The baud register 104 may store the baud value. The baud value may be used by the baud rate generator 106 to calculate a baud rate. According to one or more examples, the baud register 104 may be set when one of the plurality of settings is selected. According to one or more examples, the system 100 may receive the baud value externally and may store the baud value in the baud register 104. The baud rate generator 106 may receive an internal clock of the clock generator 102 and may calculate the baud rate based on a frequency of the received internal clock and the baud value of the baud register 104. According to one or more examples, the baud rate generator 106 may receive a clock external to the clock generator 102 and may calculate the baud rate based on a frequency of the received external clock XCK and the baud value of the baud register 104. The baud rate generator 106 may provide the baud rate to the transmitter 118 and the receiver 134. The baud rate generator 106 may also provide the baud rate to a first pad 110, which may receive the external clock (XCK) signal that may be used to generate the baud rate according to one or more examples.

The transmitter 118 may include a transmit data buffer 120 to store a data 122 (TX data 122), an encoding circuitry 124 operatively coupled to the transmit data buffer 120 and a transmit shift register 126 operatively coupled to the encoding circuitry 124 to shift out an encoded data in a bitwise manner. The bitwise manner may correspond to one bit at a time. The encoded data may be sent to a transmit pad 128 (TXD 128) which may be operatively coupled to the transmit shift register 126.

The transmit pad 128 (TXD) may serve as an output path for the encoded data. The transmit pad 128 (TXD) may transmit the encoded data in the bitwise manner, one bit at a time, synchronized with the baud rate provided by the baud rate generator 106.

The receiver 134 may receive a received data frame from a receive pad 130 (RXD) through a third selection circuitry 132 in the serial communication protocol. The receiver 134 may receive the encoded data through the third selection circuitry 132. The receiver 134 may include a receive shift register 136 operatively coupled to the third selection circuitry 132 to receive the encoded data, a decoding circuitry 138 operatively coupled to the receive shift register 136 and a receive data buffer 140 operatively coupled to the decoding circuitry 138 to receive and store a decoded data 142 (RX data 142).

The third selection circuitry 132 may function as a multiplexer. The third selection circuitry 132 may receive the encoded data from the transmit shift register 126 of the transmitter 118 and the received data frame from the receive pad 130 (RXD). The receive pad 130 (RXD) may serve as an input path for the received data frame. The third selection circuitry 132 may transmit the encoded data in the bitwise manner, one bit at a time, synchronized with the baud rate provided by the baud rate generator 106. The receive pad 130 (RXD) may be operatively coupled to the third selection circuitry 132. The third selection circuitry 132 may allow transmitting and receiving data using the same transmit pad (TxD) 128, or to use separate transmit and receive pads (TxD and RxD) 128, 130. According to various examples, the third selection circuitry may be used to detect data collisions because data transmitted to the transmit pad 128 is also received by the receiver 134 via the third selection circuitry 132. The CPU (not shown) may compare the transmitted data to the received data to confirm that they are the same.

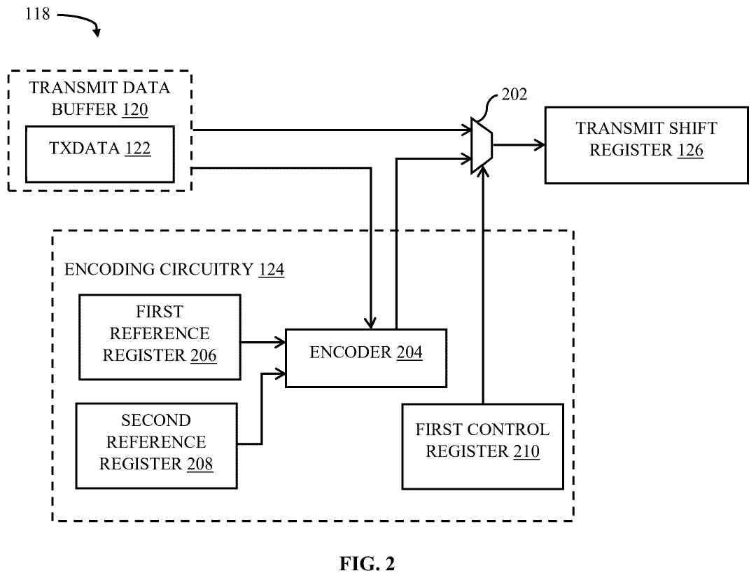

FIG. 2 shows a block diagram illustrating the transmitter 118 of the system 100 encoding in the communication protocol according to one or more examples. The transmit data buffer 120 of the transmitter 118 may provide the data 122 (TX Data 122) for transmission. The data 122 may be sent to a multiplexer 202 of the transmitter 118. The data 122 may be fed into the encoding circuitry 124 of the transmitter 118. The encoding circuitry 124 may include an encoder 204, a first reference register 206, a second reference register 208, and a first control register 210. The encoding circuitry 124 may receive the data 122 from the transmit data buffer 120 in a bitwise manner. The encoding circuitry 124 may select an encoding method based on a first control signal received from the first control register 210. The encoding circuitry 124 may encode the data 122 based on the selected encoding method and at least one of a first plurality of reference data values. The transmit shift register 126 may receive the encoded data one byte at a time for multiple bytes (e.g., 8 bytes for an 8-bit frame), and transmit the encoded data in the bitwise manner.

The first plurality of reference data values for the encoding may include a first encoding data value and a second encoding data value. In one or more examples, the first encoding data value is 0. The first encoding data value may be stored in the first reference register 206 of the encoding circuitry 124. In one or more examples, the second encoding data value is 1. The second encoding data value may be stored in the second reference register 208 of the encoding circuitry 124. The encoding method may be decided by a plurality of control bits within the first control register 210. The first control register 210 may include information about using the first reference register 206 and the second reference register 208. The encoder 204 may encode the data 122 and transmit the encoded data to the multiplexer 202. For example, if the encoder 204 receives an 8-bit string of alternating 0s and 1s in data 122 (i.e., 01010101), the encoder would alternately transmit the frames of the first reference register 206 (storing first encoding data value 0) and the second reference register 208 (storing second encoding data 1). However, other encoding modes may be used. The multiplexer 202 may send the encoded data to the transmit shift register 126 if the first control signal from the first control register 210 enables the encoding circuitry 124. If the first control signal disables the encoder, the multiplexer 202 outputs the un-encoded data 122 received from the transmit data buffer 120 to the transmit shift register 126.

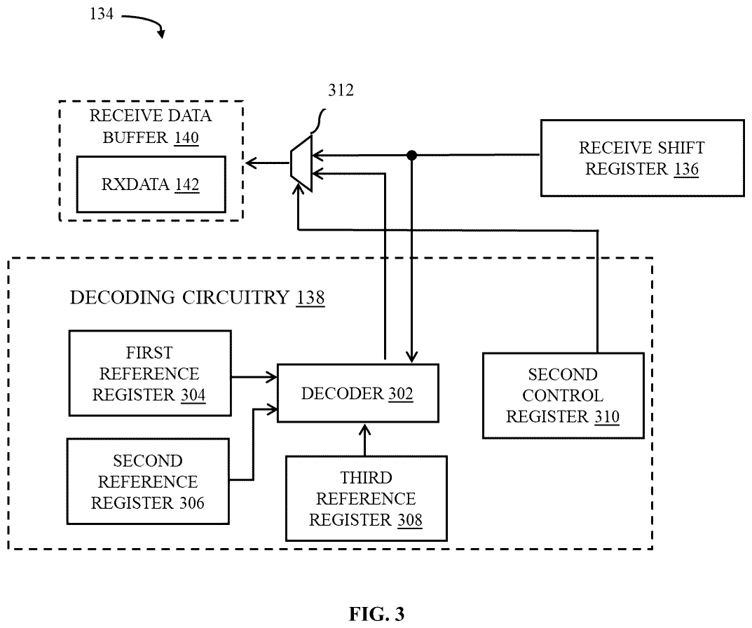

FIG. 3 shows a block diagram illustrating the receiver 134 of the system 100 for decoding data in the communication protocol according to one or more examples. The receive shift register 136 of the receiver 134 may provide the encoded data. The encoded data may be sent to the receive data buffer 140. The encoded data may be fed into the decoding circuitry 138 of the receiver 134. The decoding circuitry 138 may include a decoder 302, a first reference register 304, a second reference register 306, a third reference register 308 and a second control register 310. The decoding circuitry 138 may receive the encoded data from the receive shift register 136 in a parallel manner. For example, the receive shift register 136 may shift the bitwise data into a full byte, before transferring the byte to the decoding circuitry 138 in a parallel manner. The decoding circuitry 138 may select a decoding method based on a second control signal received from the second control register 310. The decoding circuitry 138 may decode the encoded data based on the selected decoding method and a second plurality of reference data values. The decoder 302 may output the decoded data to a multiplexer 312 of the receiver 134, which may also receive the encoded data from the receive shift register 136 and the second control signal from the second control register 310. The multiplexer 312 may selectively output the encoded data or the decoded to the receive data buffer to store as received data 142 based on the second control signal.

The second plurality of reference data values for the decoding may include a first decoding data value, a second decoding data value and a third decoding data value. In one or more examples, the first decoding data value is 0. The first decoding data value may be stored in the first reference register 304 of the decoding circuitry 138. In one or more examples, the second decoding data value is 1. The second decoding data value may be stored in the second reference register 306 of the decoding circuitry 138. In one or more examples, the third decoding data value may be a mask value. The third decoding data value may be stored in the third reference register 308 of the decoding circuitry 138. The mask value may be used during a masked decoding method. The masked decoding method may be used, without limitation, in an error correction, a data filtering and a protocol adaptation. The decoding method may be decided by a plurality of control bits within the second control register 310. The second control register 310 may include an information about using the first reference register 304, the second reference register 306 and the third reference register 308. The decoder 302 may decode the encoded data and transmit the decoded data 142 (RX Data 142) to the receive data buffer 140. For example, the decoding circuitry 138 may receive multiple bytes, decode the multiple bytes, and transfer corresponding bits to the receive data buffer 140. As used herein according to various examples, a “byte” of data refers to the data payload (i.e., not including start, stop, and parity bits), which may include 8 bits, though a greater or lesser number of bits may be used.

Various decoding modes may be used according to one or more examples. For example, each received frame may correspond to one of the first and second reference registers 304, 306 of the decoding circuitry 138, which determines whether the frame is a 1 or 0. According to various examples, a masked mode may be used in which a 1 is decoded if the following condition is met: (DATA & REFDATA2)=(REFDATA 1 & REFDATA2), where DATA is the encoded data, REFDATA1 is the first decoding data value stored in the first reference register 304, and REFDATA2 is the second decoding data value stored in the second reference register 306. In the example masked mode, a 0 is decoded if the frame is not decoded as a 1. The encoding and decoding modes provided herein are examples, and are not limiting.

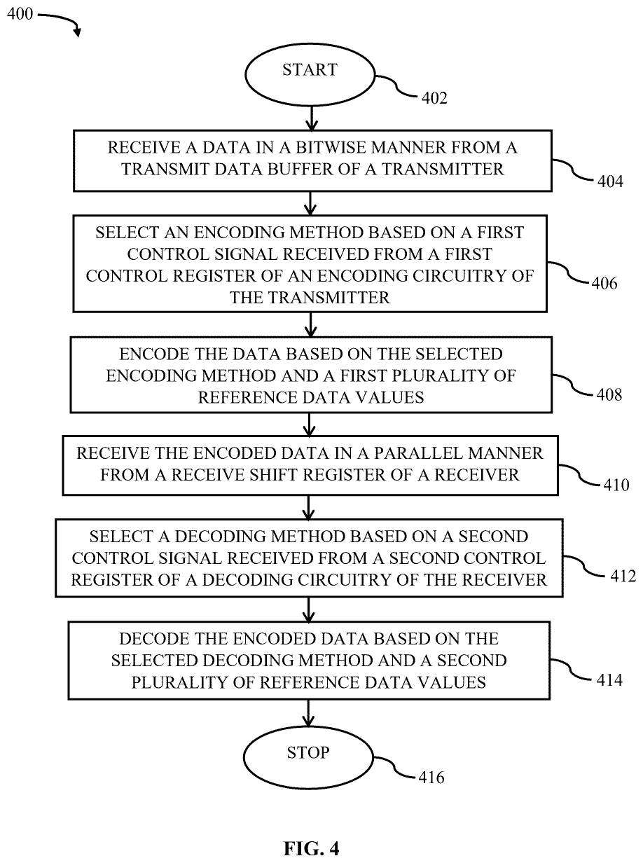

FIG. 4 shows a flowchart 400 illustrating a method for encoding and decoding data in a communication protocol according to one or more examples. It may be noted that in order to explain the method operations of the flowchart 200, references will be made to the elements explained in FIG. 1, FIG. 2 and FIG. 3.

The flowchart 400 starts at operation 402. At operation 404, the method may include receiving the data 122 in a bitwise manner from the transmit data buffer 120 of the transmitter 118. At operation 406, the method may include selecting the encoding method based on the first control signal received from the first control register 210 of the encoding circuitry 124 of the transmitter 118. At operation 408, the method may include encoding the data 122 based on the selected encoding method and the first plurality of reference data values. At operation 410, the method may include receiving the encoded data in a parallel manner from the receive shift register 136 of the receiver 134. At operation 412, the method may include selecting the decoding method based on the second control signal received from the second control register 310 of the decoding circuitry 138 of the receiver 134. At operation, 414, the method may include decoding the encoded data based on the selected decoding method and the second plurality of reference data values.

The flowchart 400 terminates at operation 416. It may be noted that the flowchart 400 is explained to have above stated process operations; however, those skilled in the art would appreciate that the flowchart 400 may have a greater or fewer number of process operations which may enable all the above stated embodiments of the present disclosure.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A system for encoding and decoding in a communication protocol, the system comprising:
a transmitter comprising:
a transmit data buffer to store a data;
an encoding circuitry operatively coupled to the transmit data buffer, wherein the encoding circuitry is to:
receive the data from the transmit data buffer; and
encode the data based on a selected encoding method; and
a transmit shift register operatively coupled to the encoding circuitry, wherein the transmit shift register is to receive the encoded data and transmit the encoded data in the bitwise manner; and
a receiver comprising:
a receive shift register to receive the encoded data;
a decoding circuitry operatively coupled to the receive shift register, wherein the decoding circuitry is to:
receive the encoded data from the receive shift register in a parallel manner; and
decode the encoded data based on a selected decoding method; and
a receive data buffer operatively coupled to the decoding circuitry, wherein the receive data buffer is to receive the decoded data.

2. The system of claim 1, wherein the encoding circuitry comprises a first control register to provide a first control signal; and
wherein the selected encoding method is selected based on the first control signal from the first control register.

3. The system of claim 2, wherein the transmitter comprises a multiplexer to selectively output the data or the encoded data to the transmit shift register based on the first control signal.

4. The system of claim 2, wherein the encoding circuitry comprises:
a first reference register to store a first encoding data; and
a second reference register to store a second encoding data;
wherein the encoding circuitry is to encode the data based on at least one of the first encoding data and the second encoding data.

5. The system of claim 4, wherein the decoding circuitry comprises a second control register to provide a second control signal; and
wherein the selected decoding method is selected based on the second control signal from the second control register.

6. The system of claim 5, wherein the receiver comprises a multiplexer to selectively output the encoded data or the decoded data to the receive data buffer based on the first control signal.

7. The system of claim 5, wherein the decoding circuitry comprises:
a first reference register to store a first decoding data;
a second reference register to store a second decoding data; and
a third reference register to store a third decoding data;
wherein the decoding circuitry is to decode the encoded data based on at least one of the first decoding data, the second decoding data, and the third decoding data.

8. The system of claim 1, comprising a baud rate generator for generating a baud rate for the system, wherein the transmit shift register is to transmit the encoded data in the bitwise manner based on the baud rate.

9. The system of claim 8, wherein the receive shift register is to transmit encoded data to the decoding circuitry in the bitwise manner based on the baud rate.

10. The system of claim 8, wherein the baud rate generator generates the baud rate based on an external clock signal.

11. A method for transmitting and receiving encoded and decoded data in a communication protocol, the method comprising:
receiving a data from a transmit data buffer of a transmitter;
encoding the data based on a selected encoding method;
transmitting the encoded data in a bitwise manner;
receiving the encoded data in a parallel manner from a receive shift register of a receiver; and
decoding the encoded data based on a selected decoding method.

12. The method of claim 11, comprising selecting the selected encoding method based on a first control signal received from a first control register of an encoding circuitry of the transmitter.

13. The method of claim 12, comprising selectively transmitting the data or the encoded data based on the first control signal.

14. The method of claim 12, wherein the encoding comprises encoding the data based a first plurality of reference data values stored in one or more reference registers of the encoding circuitry.

15. The method of claim 14, comprising selecting the selected decoding method based on a second control signal received from a second control register of a decoding circuitry of the receiver.

16. The method of claim 15, comprising selectively storing the encoded data or the decoded data based on the second control signal.

17. The method of claim 15, wherein the decoding comprises decoding the encoded data based a second plurality of reference data values stored in one or more reference registers of the decoding circuitry.

18. The method of claim 11, comprising:
generating a baud rate;
wherein the encoded data is transmitted in the bitwise manner based on the baud rate.

19. The method of claim 18, wherein the encoded data is received in the bitwise manner based on the baud rate.

20. The method of claim 18, wherein the baud rate is generated based on an external clock signal.
